(19) United States
(12) Patent Application Publication
(10) Pub. No.: US 2014/0081749 A1
(43) Pub. Date: Mar. 20, 2014

(54) CUSTOMIZED TELEVISION COMMERCIALS

(71) Applicants: Tamer E. Abuelsaad, Somers, NY (US); John Elbert Moore, JR., Brownsburg, IN (US); Rajeshkumar N. Singi, Marietta, GA (US); Robert Richard Wentworth, Round Rock, TX (US)

(72) Inventors: Tamer E. Abuelsaad, Somers, NY (US); John Elbert Moore, JR., Brownsburg, IN (US); Rajeshkumar N. Singi, Marietta, GA (US); Robert Richard Wentworth, Round Rock, TX (US)

(73) Assignee: International Business Machines Corporation, Armonk, NY (US)

(21) Appl. No.: 13/618,807

(22) Filed: Sep. 14, 2012

Related U.S. Application Data
(63) Continuation of application No. 13/617,693, filed on Sep. 14, 2012.

(51) Int. Cl. G06Q 30/02

(52) U.S. Cl. 705/14.53

(57) ABSTRACT

A media player includes a memory device storing a computer program, a processor configured to execute the computer program, and network interface configured to enable communications between the media player and a network. The program is configured to download a data portfolio from a remote server across the network, determine whether one of a plurality of commercials included within the data portfolio has been viewed previously by a same viewer, and output an other one of the commercials based on a viewing strategy included within the data portfolio.

### CROSS-REFERENCE TO RELATED APPLICATIONS

This application is a continuation of U.S. application Ser. No. 13/617,693 filed on Sep. 14, 2012, the disclosure of which is incorporated by reference herein.

### BACKGROUND

1. Technical Field

The present disclosure relates to the field of targeted advertising data presentation.

2. Discussion of Related Art

One traditional form of advertising is the television commercial. A television commercial typically consists of brief advertising spots that range in length from a few seconds to several minutes. The commercials appear between shows and interrupt the shows at regular intervals. For example, for every five minutes a nature show is broadcasted, a 30 second commercial about toothpaste could be broadcast before resuming the show. Thus, the same viewer could be exposed to the same commercial for the same product several times while watching the show. Advertisers have found that a viewer is more likely to purchase a product based on viewing several different commercials for the same product. Currently, a television network broadcasts set commercials at set times independent of whether the viewers have actually watched the commercials.

Accordingly, there is a need for methods and systems that enable a manufacturer to present different versions of commercial to a same viewer.

### BRIEF SUMMARY

According to an exemplary embodiment of the invention, a method of presenting a commercial to a viewer by a media player includes downloading, by the media player, a data portfolio from a remote sever, wherein the data portfolio comprises a plurality of commercials and a viewing strategy, determining, by the media player, whether one of the commercials has been viewed previously by a same viewer, and presenting, by the media player, an other one of the commercials based on the viewing strategy.

According to an exemplary embodiment a method of presenting a commercial to a viewer by a server includes downloading, by the server, information from a media player, wherein the information indicates whether one of a plurality of commercials included within a data portfolio has been viewed previously by a same viewer, and transmitting, by the server, an other one of the commercials to the media player based on a viewing strategy associated with the data portfolio.

According to an exemplary embodiment of the invention, a media player includes a memory storing a computer program, a processor configured to execute the program, and a network interface configured to enable communications between the media player and a network. The program is configured to download a data portfolio from a remote sever across the network, determine whether one of a plurality of commercials included within the data portfolio has been viewed previously by a same viewer, and output an other one of the commercials based on a viewing strategy included within the data portfolio.

According to an exemplary embodiment of the invention, a server is configured to transmit video content to a media player. The server includes a memory storing a program, a processor configured to execute the program, and a network interface configured to enable communications across a network between the server and a remote media player. The program is configured to download information indicating whether one of a plurality of commercials included within a data portfolio has been viewed previously by a same viewer from the media player across the network, and transmit an other one of the commercials to the media player across the network based on a viewing strategy associated with the data portfolio.

According to an exemplary embodiment of the invention, a media system includes a network, a server configured to store a data portfolio including video content for a plurality of commercials and a viewing strategy, and a media player configured to output media received from the server across the network. The media player is configured to download the data portfolio from the server across the network, determine whether one of the commercials has been viewed previously by a same viewer, and output an other one of the commercials based on the viewing strategy.

According to an exemplary embodiment of the invention, a method of presenting a commercial to a viewer includes capturing, by a camera of a media player, an image, performing, by the media player, image recognition on the image to determine whether the image corresponds to a viewer, determining, by the media player, whether a commercial of a first version for a product has been viewed previously by the same viewer, and presenting, by the media player, a second other version of the commercial if the commercial of the first version was viewed previously by the same viewer.

According to an exemplary embodiment of the invention, a method of presenting a commercial to multiple viewers includes capturing, by a camera of a media player, an image, performing, by the media player, image recognition on the image to determine whether the image corresponds to a plurality of viewers, determining, by the media player, whether each viewer has previously viewed a commercial for a same product, and a version of the commercial viewed by each viewer, and presenting, by the media player, the commercial of the version that was viewed least.

According to an exemplary embodiment of the invention, a method of presenting a commercial to a viewer includes receiving, by a system, a computer message from a remote media player that indicates a commercial of a first version for a product has been viewed by a user of the remote media player, and transmitting, by the system, the commercial of a second other version for the same product to the remote media player after receiving the message.

According to an exemplary embodiment of the invention, a media player includes a camera, a memory storing a computer program, and a processor configured to execute the program. The program is configured to control the camera to capture an image, perform image recognition on the image to determine whether the image corresponds to a viewer, determine whether a commercial of a first version for a product has been viewed previously by the viewer, and output a second other version of the commercial for the same product when it has been determined that the commercial of the first version has been viewed previously by the same viewer.

According to an exemplary embodiment of the invention, a media system includes a television comprising a camera, a media player, and a computer. The media player provides media to the television received from a network, and receives information from the television. The computer provides the media to the media player through the network. The computer provides a plurality of different commercials for a same product within the media to the media player. The media player is configured to initially output a first one of the commercials to the television. The television is configured to capture a first image using the camera, and perform image recognition on the first image to generate the information that identifies a first viewer viewing the television. The television is configured to capture a second image using the camera, and perform image recognition on the second image to generate the information that identifies a second viewer viewing the television. The media player is configured to subsequently output a second other one of the commercials to the television if the first viewer and second viewer correspond to a same person and the same person previously viewed the first commercial.

According to an exemplary embodiment of the invention, a media player includes a camera, a memory storing a computer program, and a processor configured to execute the program. The program is configured to control the camera to capture an image, perform image recognition on the image to determine whether the image corresponds to a plurality of viewers, determine whether each viewer has previously viewed a commercial for a same product and a version of the commercial viewed by each viewer, and present the commercial of the version that was viewed least.

### BRIEF DESCRIPTION OF THE SEVERAL VIEWS OF THE DRAWINGS

Exemplary embodiments of the invention can be understood in more detail from the following descriptions taken in conjunction with the accompanying drawings in which:

FIG. 1 illustrates a system that operates in accordance with an exemplary embodiment of the present invention.

FIG. 2 illustrates a method of presenting a commercial to a viewer by a media player according to an exemplary embodiment of the invention.

FIG. 3 illustrates a method of presenting a commercial to a viewer by server according to an exemplary embodiment of the invention.

FIG. 4 illustrates another embodiment of system that operates in accordance with an exemplary embodiment of the present invention.

FIG. 5 illustrates a method of recording which versions of a commercial for a product have been viewed, according to an exemplary embodiment of the invention.

FIG. 6 illustrates a method for presenting different versions of a commercial for a product based on the recorded data, according to an exemplary embodiment of the invention.

FIG. 7 illustrates an example of a computer system capable of implementing methods and systems according to embodiments of the disclosure.

### DETAILED DESCRIPTION

Embodiments of the present invention provide a method and/or system that may be used to deliver a commercial to a viewer based on previous playing or viewing.

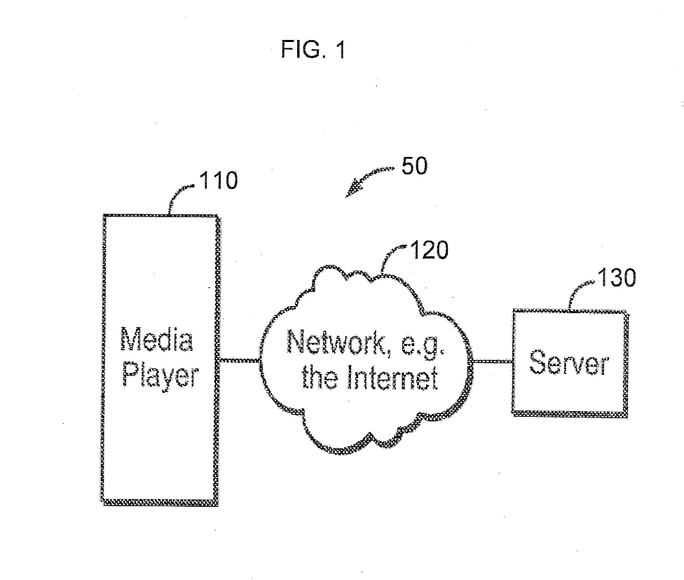

Referring to FIG. 1, there is illustrated a system 50 that operates in accordance with an embodiment of the present invention. The system 100 includes a media player 110. By way of example, the media player 110 may comprise an entertainment system, game console, game system, personal computer (PC), television (TV), handheld device, DVD player, digital video recorder (DVR), cable set-top box, stereo, CD player, audio player, radio, etc. In some embodiments the media player 110 may additionally comprise a networked device. As such, the media player 110 may be coupled to a network 120, such as the Internet. Other devices, servers, etc., may also be coupled to the network 120, such as for example the server 130.

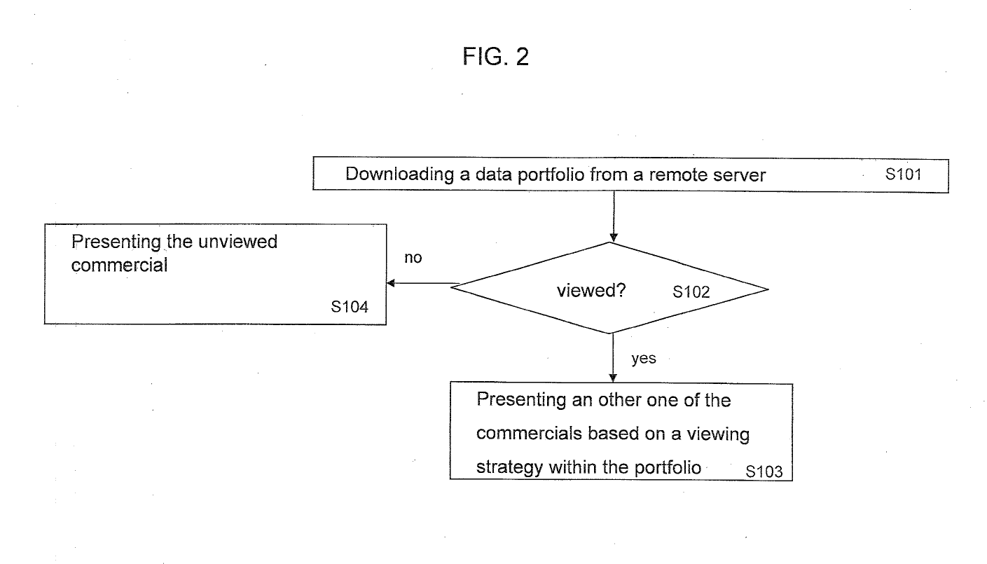

Referring to FIG. 2, a method may be performed by the media player 110 to present a commercial to a viewer according to an exemplary embodiment of the invention. The method includes the media player 110 downloading a data portfolio from the server 130 (e.g., across the network 120) (S101). The data portfolio includes video content comprising several commercials and a viewing strategy that is used by the media player 110 to determine which of the commercials is to be presented to a viewer. The data portfolio may correspond to a purchased time slot in which one of the commercials is to be presented to a viewer.

The method continues by the media player 110 determining whether one of the commercials of the data portfolio has been previously viewed (S 102). In an exemplary embodiment, if the media player 110 had previously played the commercial, it stored a record indicating such. For example, the record may indicate at least one of various information such as how many times the commercial was played by the media player 110, the times the commercial was played, the location at which the commercial was played (e.g., lat/lon, address of the residence the media player is located, etc.), etc.

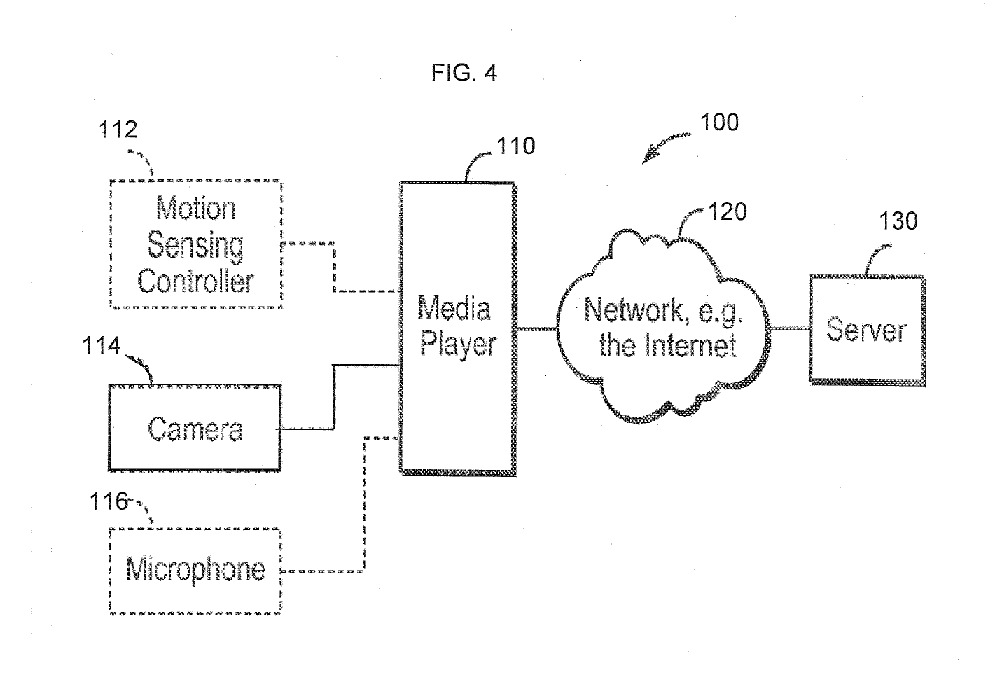

In another embodiment, the media player 110 only stores a record if the commercial was played and actually viewed by a viewer. In a further embodiment, the record indicates at least one of the identity of the viewer, the gender of the viewer, interests of the viewers, the times the commercial was viewed by the viewer, etc. Determining whether the commercial was actually viewed, the identities of the viewers, genders, interests, etc., will be discussed in more detail below with reference to FIGS. 4-6.

If it has been determined that one of the commercials has been previously viewed or played, then the media player 100 presents another one of the commercials based on the viewing strategy within the downloaded data portfolio (S 103). For example, the viewing strategy could indicate that the next commercial be chosen randomly from the remaining ones. In another example, the strategy could assign a different priority to each commercial, and the next commercial could be chosen if it has a next highest priority. Various other viewing strategies may be used as described below. If it has been determined that the commercial has not been previously viewed, then the media player 110 presents the unviewed commercial (S 104).

The media player 110 may periodically download one or more of data portfolios from the server 130. Each data portfolio may correspond to a different time slot and a different company, product, or manufacturer. The commercials stored within a data portfolio may include several different versions of a commercial for a same product, company, manufacturer, etc. If the media player 110 has already played one of these versions for a particular portfolio, its selects a different version based on the viewing strategy associated with the portfolio.

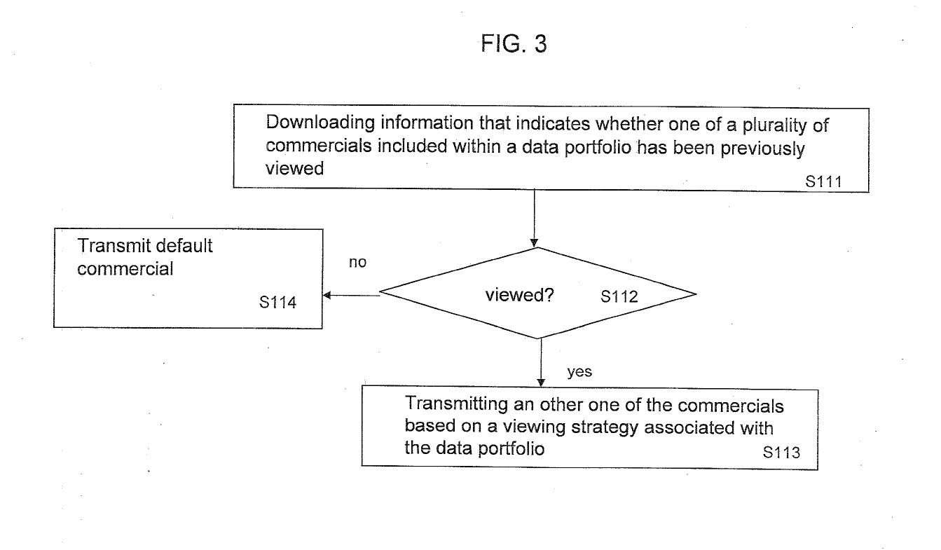

In another embodiment, the data portfolios remain on the server 130 and the server 130 determines which commercial of a given portfolio to transmit to the media player 110 based on information received from the media player 110. For example, FIG. 3 includes a step of the server 130 downloading the information that indicates whether one of the commercials included in the data portfolio has been viewed (e.g., played or actually viewed) (S111). For, example, if the media player 110 had previously played or output a particular commercial, the media player 110 can store a record indicating that the commercial was viewed. In another embodiment, the media player 110 only stores the record if it determines whether the commercial was actually viewed. Determinations of actually viewing will be discussed in more detail below with respect to FIGS. 4-6.

The record may include a commercial identifier that uniquely identifies the commercial. The record may additionally identify the media player and/or the viewer. The record may include statistics about how often the commercial was viewed and other data such as interests of the viewer or the household (e.g., average number of viewers, salary, political affiliation, geographic position, etc.). The server 130 can download the record before it is time to transmit a new commercial of the portfolio. In another embodiment, the media player 110 uploads these records to the server 130 or periodically uploads several such records to the server 130.

The server 130 examines the downloaded or uploaded information to determine which commercial of a given portfolio has been viewed or presented by the media player 110 (S112). For example, if the server 130 matches a commercial identifier of the information with one of its data portfolios it could determine that a commercial from the portfolio has been viewed by the media player 110.

The server 130 then transmits another one of the commercials within the corresponding data portfolio to the media player 110 based on a viewing strategy associated with the data portfolio (S113). For example, as discussed above, the viewing strategy could randomly select another one of the commercials, select another commercial based on its relative priority, etc.

If the server 130 is unable to match the commercial identifier with one of its data portfolios, is unable to download the information form the media player 110, or there is no information to download, the server 130 can transmit a default commercial from within a data portfolio that is scheduled to be transmitted (S114). The default commercial may be selected from the commercials of the data portfolio randomly, based on its relative priority, etc.

FIG. 4 illustrates a system 100 that is similar to the system 50 of FIG. 1, but further includes a camera 114 and optionally a motion sensing controller 112 and a microphone 116.

The camera 114 may be coupled to the media player 110 or housed within the media player 110. The camera 114 is configured to capture images, which may be used to determine whether a viewer is present.

In some embodiments the motion sensing controller 112 may comprise a hand-held controller that has the ability to have its three-dimensional movements tracked. Such tracking may be performed in many different ways. For example, such tracking may be performed through inertial, video, acoustical, or infrared analysis.

The information received from the sensors such as the motion sensing controller 112, the microphone, and/or the camera 114, may be analyzed for the additional purpose of forming at least an indication of the viewer's level of attention to one or more portions of the content being played by the media player 110.

In some embodiments, the camera 114 is the only sensor coupled to a device such as a PC, cable set-top box, network consumer electronic device, or other device. The information received from the camera 114 may be used to form at least an indication of the user's level of attention to one or more portions of the content. For example, the camera 114 may be embedded within a television or a cable-set-top box, and the information received from the camera 114 may be used to form at least an indication of the user's level of attention to cable television advertisements or programs.

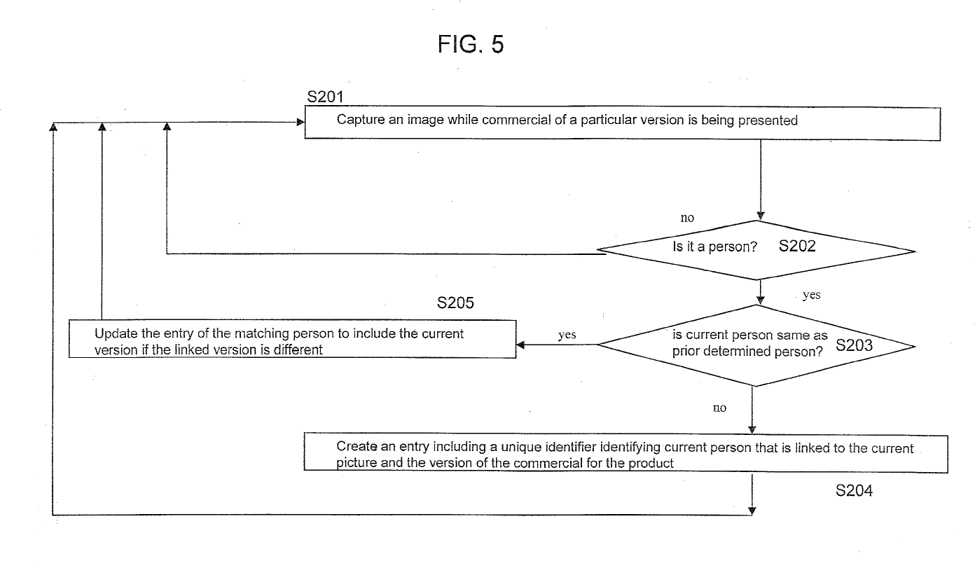

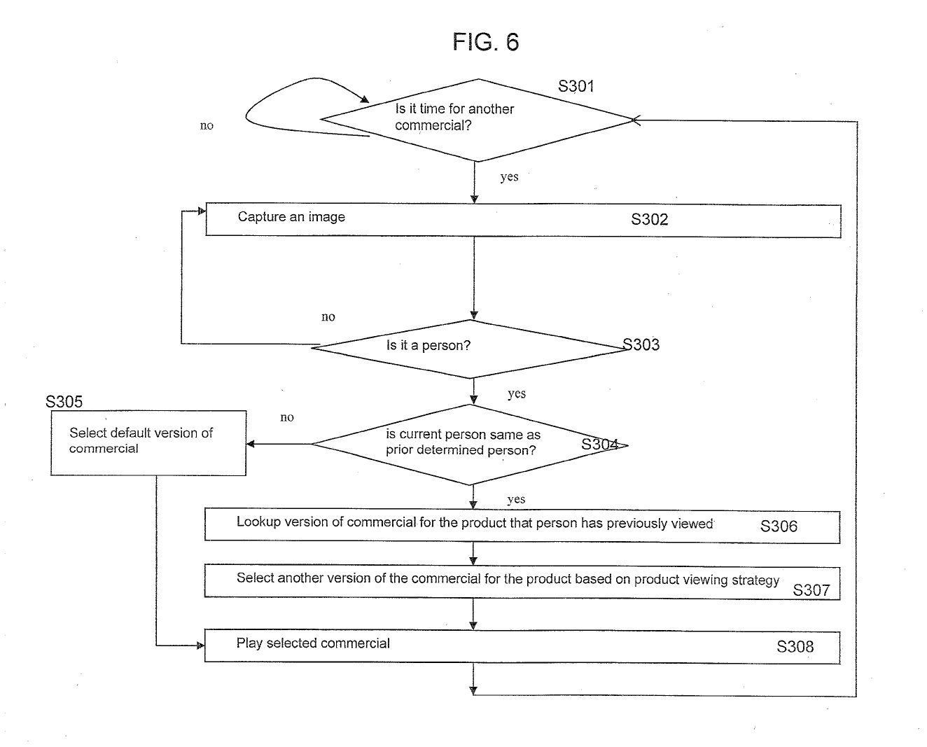

Referring to FIG. 5 and FIG. 6, there are illustrated methods 200 and 300 that operate in accordance with an embodiment of the present invention. The methods 200 and 300 may be used with a media player such as, for example, any of those described above.

The method 200 begins in block S201 where the media player 110 captures an image (e.g., using camera 114) while a commercial/advertisement of a particular version (e.g., version 1, version 2) for a product or company is being presented.

The version of the commercial that is being played by the media player 110 may be embedded within the electronic data that includes video of the commercial. The server 130 may be configured to perform this embedding and transmit (e.g., via network 120) one or more versions of the commercial for the same product/company to the media player 110.

The electronic data may be the above-described data portfolio. For example, the data portfolio may include several versions of the commercial for the same product/company along with the viewing strategy. For example, the viewing strategy could indicate that version 1 of the commercial for toothpaste is preferred for male viewers, while version 2 of the commercial is preferred for female viewers. The viewing strategy could also give each version of the commercial for the product a different priority. Thus, if it's the first time that a commercial for the product is being presented, the media player 110 could present the version with the highest priority.

The media player 110 can be configured to only capture images when a screen coupled to the media player 100 is powered-on or only when its video input is set to the same video input in which the commercial is being presented. For example, if the commercial is output to a first HDMI port and the screen is currently viewing the second HDMI port, the media player 110 need not capture images since the viewer cannot be watching the commercial.

In block S202, image recognition is performed by the media player 110 on the captured image. In image recognition, the media player extracts features from the captured image and uses one or more algorithms to determine how likely these features correlate with a human being. These algorithms may include a facial recognition algorithm that assumes a person is present if certain minimal facial features are present (e.g., two eyes, a noise, and a mouth). In another embodiment, these algorithms determine that a person is present if a minimal amount of body part features are present (e.g., a head, torso, legs, etc.).

The media player 110 may additionally use data received from the motion sensing controller 112 and/or sound bites captured by the microphone 116 to confirm whether the image initially considered to be a person is in fact a person. For example, if the camera 114 had captured an image of a portrait of a person, it might assume a viewer is present unless additional information if examined. If the motion sensing controller 112 additionally indicates the presence of movement and/or sound bites are received that are within the frequency range of human speech, then it is more likely that the captured image corresponds to an active viewer.

If the image is not that of person, then the image can be discarded, and the method resumes to block S201. Although not shown in FIG. 2, once it has been determined that the image includes a person, the method 200 may further use the results of the image recognition, the motion sensing controller 112, and/or the microphone 116 to determine the level of interest of that person. For example, if the head of the viewer is determined to be turned away from the screen, this image can be discarded and the method can resume to block S201.

If the image is that of a person, and the level of interest is high enough or is not considered, then the method 200 continues to block S203, where it determines whether the identified person is the same as a prior identified person. The determination can be performed by comparing features of the captured image against features of previously captured images. Similarity metrics can be generated for each comparison. If the similarity metric generated from the captured image and all prior captured images is outside a threshold range, the current image is assumed to be that of a new person.

The determination of whether the current person is the same as a prior person may be augmented with speech data captured by the microphone 116 or motion data captured by the motion sensing controller 112. For example, the microphone 116 may have captured sound bites when the prior captured images were captured and when the current image was captured. If a previously captured image is similar to the current captured image, and if a pattern of speech in sound bites associated with the previously captured image is similar to a pattern of speech in sound bites associated with the current captured image, it is more likely that the same person has been identified. Further, as discussed above, the motion data can be used to rule out the possibility that the captured image is that of a portrait.

If it is determined that the image is that of a new person (e.g., an active viewer), the media player 110 can record information that enables the media player 110 to play a different version of the commercial for the same product at a later time. This will be explained in more detail with respect to FIG. 3 below. The recording of the information may include creating an entry including an identifier that uniquely identifies the current person/viewer, and which is linked to the current image and the current version of the commercial for the product (S204).

If it is determined that the image is that of a prior person/viewer, the media player 110 can update the existing entry associated with that prior person/viewer to include the version of the commercial presented, assuming it is different from that previously watched by the prior person (S205). This update could overwrite the prior watched version with the new version or append the new version after the prior watched version. Further, the image associated with the entry could be updated with the newly captured image or the prior captured image could be maintained.

The below Table 1 illustrates examples of the above-described entries for commercials for products of toothpaste, cereal, and applesauce that each have three different versions. However, the number of commercial for a same product and the products themselves may vary in alternate embodiments.

TABLE 1

| Viewer Identifier | Image | Ad Version(s) |
|---|---|---|
| Subject 1 | Image1.tiff | Toothpaste(1), Applesauce(1,3) |
| Subject 2 | Image2.tiff | Cereal(3), Toothpaste(2,3) |
| Subject 3 | Image3.tiff | Toothpaste(1,2,3), Cereal(1,2) |
| Subject 4 | Image4.tiff | Applesauce(2) |

The above Table 1 is merely an example, as the information regarding the identities of the persons determined to have viewed different commercial versions for the same product can be organized in various ways. Further, additional information can be stored for each viewer identified (e.g., a sound bite associated with the viewer, motion information, demographic information, gender information, interests, age, etc.).

In an exemplary embodiment, some of the additional information is determined automatically through image recognition. For example, the image recognition can perform an algorithm to predict the age or gender of the viewer. The media player 110 can determine the interests or the demographics of the user by searching social networks for users with the same or similar image and then by mining for this data on pages of the social network published by the user.

The method 300 begins in block S301 where the media player 110 determines whether it is time to present another commercial for the same product. The media player 110 can periodically download a schedule form the server 130 that indicates when a commercial for the product is to be presented and when programs are to be presented. For example, assume the schedule indicates that program A will have a break in 2 minutes, and during the break, a commercial for toothpaste will be broadcast. Since it will soon be time to present the commercial, the method continues to block S302, where the media player 110 captures an image.

Next, in block S303, the media player 110 performs image recognition on the image to determine whether a person is present in the image. As discussed above, this determination may be augmented by data sensed by the motion sensing controller 112 and/or the microphone 116.

If the image is not that of a person, the media 110 player can attempt to capture another image (S302). In an alternate embodiment, the method resumes to block S305 if the image is not that of a person, and decides that a default version of the commercial for the product will presented at the scheduled time.

If the image is deemed to be that of a person, then the media player 110 determines whether this current person is the same as a prior determined person (S304). For example, similar to block S203, the media player 110 compares features of the captured image against those it has previously captured to determine whether this image is that of person that has previously viewed a commercial. For example, if the image is similar to one of the entries in Table 1, it can be determined that the current person is the same as a prior determined person.

Then the method 300 continues to block S306 to lookup the version of the commercial for the product that was previously viewed by that person. For example, if it was determined that the image corresponds to Subject 1, it is determined that Subject 1 previously viewed version 1 of the toothpaste commercial by referring to Table 1.

Next, the method 300 continues to block S307. In block S307, the media player selects another one of the available versions of the commercial for the product based on the product viewing strategy. The viewing strategy may be different for each product, manufacturer, or viewer. An example of a viewing strategy could be to randomly select one of the other versions of the commercial of the same product or to select the next one with the highest priority. However, embodiments of the invention are not limited to any particular viewing strategy. Once the version of the commercial has been selected, it can be played by the media player 110 at the scheduled time (S308). Ideally, the method 300 is performed soon before the commercial is scheduled to be played to ensure that the viewer has not left his viewing position.

In an another embodiment of the invention, the media player 110 is capable of discerning multiple people from a single captured image, and then deciding what commercial version to present based on the two captured images. For example, referring to FIG. 5, block S202 can be modified to determine whether the image includes more than one person. Assuming block S203 was able to find at least two viewers in the image, then block S203 can be modified to determine whether the at least two viewers correspond to prior determined persons. If one is determined to be a prior viewer and the other is determined to be a new viewer, then block S204 can be used to create an entry for the new viewer and block S205 can be used to update the existing entry for the existing viewer.

Similarly, block S303 and S304 of FIG. 6 can be modified to determine whether there are multiple viewers present within the captured image, and whether the at least two viewers are the same as a prior determined person, respectively. However, in this example, some of viewers could have previously viewed different versions of the commercial. Thus, the next version of the commercial to be presented could be that of the one that was least seen overall or another one that was not seen by any of the viewers.

In an exemplary embodiment, the media player 110 is configured to send information and/or statistics in a computer message across the network 120 to the server 130. For example, the media player 110 can send various data, such as what commercials were seen by each viewer, what were the versions seen, how frequently was each commercial seen, what was the time a commercial was most often seen, data about each viewer (e.g., predicted age, gender), household data (e.g., average number of viewers, average age of viewers, makeup of family), etc. The media player 110 may also send this information back to the advertisers and/or broadcasters of the programming indirectly through the server 130 or directly via the internet.

In another embodiment, the media player 110 is configured to capture images and perform image recognition while a particular show is being presented. The media player 110 can record various information for each viewer or for the viewers of the home as a whole, such as the name of the program watched, the time it was watched, the frequency at which the program is watched, the types of programs watched (e.g., sports, nature programs, etc.), the most frequently watched time slots (e.g., 8-9 pm Friday, 6-7 pm Saturday, etc.). Similarly, the media player 110 can send the information about the programs watched to the server 130, to manufacturers, broadcasters, etc.

In at least one embodiment, part of the tasks described above with respect to the media player 110 is offloaded to the server 130. For example, the server 130 can be configured to send a command via computer message to the media player 110 to request that the media player 110 capture an image, sound, motion, etc., while the server 130 is currently broadcasting a particular show or a particular commercial. In response to the request, the media player 110 uses the appropriate sensor (e.g., camera 114, microphone 116, and motion sensing controller 112) to capture the corresponding data and then transmits the sensed data to the server 130 via the network 120. The server 130 then analyzes the data in a similar manner to that discussed above by the media player 110. For example, the server 130 can perform image recognition, sound analysis, motion analysis to determine whether the captured data corresponds to a viewer, the level of interest of the viewer, and the current program or commercial being watched. The server 130 can later request that the media player 110 collect sensed data at or near a time it has scheduled a commercial for a product to be presented. The server 130 can use the sensed data in a similar manner described above with respect to the media player 110 to determine which version of a commercial for a product should be presented to the identified viewer and then transmit the commercial version to the media player 110.

In another embodiment, the media player 110 performs the image recognition, sound recognition, etc., to determine what program and/or commercial has been viewed by each user, and sends this information along with the current viewer to the server 130. The server 130 then decides what commercial to send to the media player 110 based on this information. The information may be formatted within a computer message that is sent across the network 120 to the server 130. The computer message may indicate the version of the commercial, the product viewed (e.g., a product identifier), a viewer identifier (e.g., an ID to represent the viewer, the name of the viewer, the address of the viewer, etc.), the time the commercial was viewed, and additional information about the viewer (e.g., gender, age, interests, demographics, etc.).

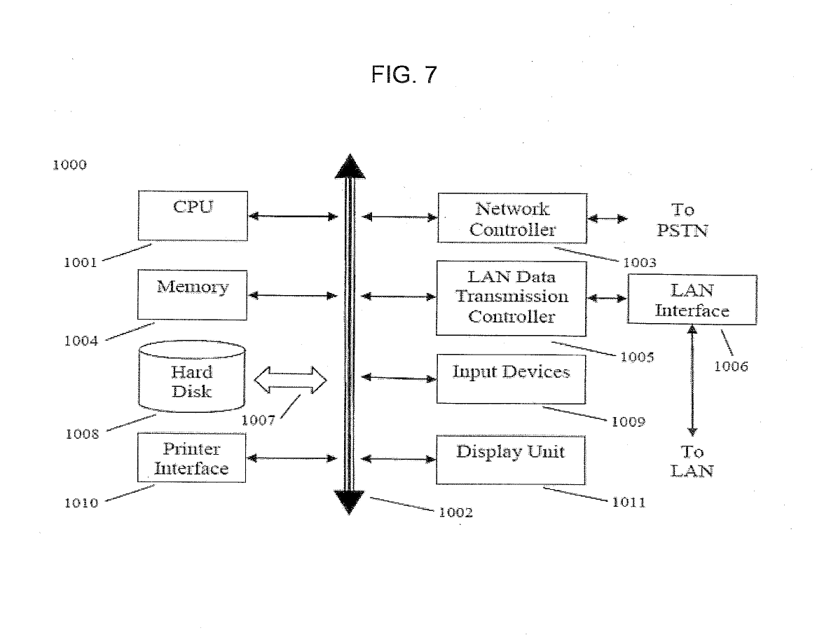

FIG. 7 illustrates an example of a computer system, which may execute any of the above-described methods, according to exemplary embodiments of the invention. For example, the method of FIG. 2, FIG. 3, FIG. 5, and FIG. 6, may be implemented in the form of a software application running on the computer system. Further, portions of the method of FIGS. 2-3 and 5-6 may be executed on one such computer system, while the other portions are executed on one or more other such computer systems. For example, the method of FIG. 5 could be located on one computer system while the method of FIG. 6 is located on another computer system. Examples of the computer system include a mainframe, personal computer (PC), a cable set-top box, a television microprocessor, a handheld computer, a server, etc. The software application may be stored on a computer readable media (such as hard disk drive memory 1008) locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. For example, the display unit 1011 may be used to present video including the commercials and television programs. The display unit 1011 could be a television that has various inputs such as HDMI. As shown, the system 1000 may be connected to a data storage device, for example, a hard disk 1008 (e.g., a digital video recorder), via a link 1007. CPU 1001 may be the computer processor that performs the above described methods.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A media player comprising:
a memory device storing a computer program;
a processor configured to execute the computer program; and
a network interface configured to enable communications between the media player and a network,
wherein the program is configured to download a data portfolio from a remote server across the network, determine whether one of a plurality of commercials included within the data portfolio has been viewed previously by a same viewer, and output an other one of the commercials based on a viewing strategy included within the data portfolio.

2. The media player of claim 1, wherein the media player includes a display and the commercial is output to the display.

3. The media player of claim 1, wherein the media player is a television or a cable set-top box.

4. The media player of claim 1, wherein the commercials include at least two different versions of a commercial for a same product or company.

5. The media player of claim 1, wherein the download retrieves a computer formatted message comprising the data portfolio, the data portfolio comprising video content for each commercial.

6. The media player of claim 1, wherein the viewing strategy indicates that the other commercial is the commercial viewed least by the same viewer.

7. The media player of claim 1, wherein the viewing strategy assigns a priority to each commercial, and the other commercial is the commercial with the next highest priority.

8. The media player of claim 1, wherein the viewing strategy selects the other commercial randomly.

9. The media player of claim 1, further comprising a camera, wherein the program determines whether one of the commercials has been viewed previously by a same viewer by controlling the camera to capture an image, performing a facial recognition on the image to determine whether the image corresponds to a previous viewer, and determining whether the previous viewer is linked to the one commercial.

10. The media player of claim 9, wherein the program is configured to play media at a normal rate and a faster rate for fast forwarding of the media, and the program is prevented from capturing images while playing the media at the faster rate.

11. The media player of claim 9, wherein the memory stores at least one image and the program stores the captured image in the memory only if it differs substantially from the previously captured images.

12. The media player of claim 1, wherein the program is configured to send statistics about the viewer to the server.

13. A server configured to transmit video content to a media player, the server comprising:
a memory device storing a program;
a processor configured to execute the program; and
a network interface configured to enable communications across a network between the server and a remote media player,
wherein the program is configured to download information indicating whether one of a plurality of commercials included within a data portfolio has been viewed previously by a same viewer from the media player across the network, and transmit an other one of the commercials to the media player across the network based on a viewing strategy associated with the data portfolio.

14. The server of claim 13, wherein the commercials include at least two different versions of a commercial for a same product or company.

15. The server of claim 13, wherein the program downloads the information by retrieving a computer formatted message including the information across the network from the media player.

16. The server of claim 13, wherein the information indicates statistics about the viewer.

17. The server of claim 13, wherein the program transmits the other commercial in a computer formatted message to the media player that includes video content for the corresponding commercial.

18. The server of claim 13, wherein the viewing strategy indicates that the other commercial is the commercial viewed least by the same viewer.

19. The server of claim 13, wherein the viewing strategy assigns a priority to each commercial, and the other commercial is the commercial with the next highest priority.

20. The server of claim 13, wherein the viewing strategy selects the other commercial randomly.

21. A media system comprising:
a network;
a server configured to store a data portfolio including video content for a plurality of commercials and a viewing strategy; and
a media player configured to output media received from the server across the network,
wherein the media player is configured to download the data portfolio from the server across the network, determine whether one of the commercials has been viewed previously by a same viewer, and output an other one of the commercials based on the viewing strategy.

22. The system of claim 21, wherein the commercials include at least two different versions of a commercial for a same product or company.

23. The system of claim 21, wherein the viewing strategy indicates that the other commercial is the commercial viewed least by the same viewer.

24. The system of claim 21, wherein the viewing strategy assigns a priority to each commercial, and the other commercial is the commercial with the next highest priority.
